(19) United States
(12) Patent Application Publication
(10) Pub. No.: US 2011/0174054 A1
(43) Pub. Date: Jul. 21, 2011

(54) DEVICE FOR MEASURING AIR QUALITY

(76) Inventor: Craig Lynn, Renfrew (GB)

(21) Appl. No.: 13/054,718

(22) PCT Filed: Jun. 25, 2009
(86) PCT No.: PCT/GB09/50736

§ 371 Date: Mar. 25, 2011

(30) Foreign Application Priority Data
Jul. 28, 2008 (GB) 0813749.9

(51) Int. Cl. G01N 7/00

(52) U.S. Cl. 73/31.02

(57) ABSTRACT

There is herein described a device and a method for measuring and/or monitoring gas levels. More particularly, there is described a device and a method for measuring and/or monitoring pollution levels in the atmosphere and wherein the measured pollution levels are capable of being displayed in a format equivalent to a number of cigarettes per day value.

### FIELD OF THE INVENTION

The present invention relates to a device and a method for measuring and/or monitoring gas levels. More particularly, the present invention relates to a device and a method for measuring and/or monitoring air quality levels in the atmosphere.

### BACKGROUND OF THE INVENTION

Pollution levels are rising on a global level. This is causing significant concern with regard to the resulting damaging effect on the environment. There is also the significant problem that with increased levels of pollution in the atmosphere, individuals breathing in these pollutants are placing their health in risk with associated respiratory side-effects and diseases such as the onset of cancers. An elevated risk is inherent within children, where recent studies have shown increased risk of developing respiratory diseases and asthma (30 percent of childhood asthma is due to environmental exposures, costing the USA $2 billion per year.) Asthma sufferers are also at higher risk with poor air quality prone to triggered attacks. There is therefore a need for monitoring devices which can quickly and easily measure the level of pollutants in the atmosphere and identify when harmful levels have been reached. Harmful pollutants include nitrogen oxide based gases (i.e. NO_{X}) and in particular nitrogen dioxide (NO₂). Other harmful pollutants include ozone (O₃) and substances known as particulate matter (PM).

It is increasingly evident that air pollution in urban environments is rising with recent exponential increases in areas such as China and India. Individuals in these areas are therefore at significant risk from pollution in the atmosphere.

Unlike in some situations where poor air quality manifests itself to people in a visible form such as smog, in many situations the pollutants in the atmosphere cannot be observed by the naked eye. Individuals may therefore be completely unaware that they are breathing in a highly polluted atmosphere and are therefore unable to take any form of protective measures such as using face masks to protect their health.

Human bodies use NO in very small amounts to carry signals between cells. However, in large amounts NO is a major air pollutant and can directly damage lung tissue and may cause inflammation in the lungs. Epidemiological studies have shown that long-term NO₂ exposure may decrease lung function and increase the risk of respiratory problems. Normally, human bodies produce small amounts of NO, which causes our airways to expand. However, exposure to large amounts of NO results in expansion of airways, making it easier for lungs to absorb even more harmful pollutants such as NO_{X} and particulate matter (PM).

There is therefore a need to provide a device which is capable of measuring and/or monitoring polluting gas levels in the atmosphere and which is also capable of alerting an individual to the fact that they are in a polluting atmosphere that may potentially be damaging to their health.

It is an object of at least one aspect of the present invention to obviate or mitigate at least one or more of the aforementioned problems.

It is a further object of at least one aspect of the present invention to provide an improved device and/or method for measuring and/or monitoring air quality (e.g. pollution) in the atmosphere.

It is a further object of at least one aspect of the present invention to provide a portable device for measuring and/or monitoring air quality in the atmosphere.

It is a yet further object of at least one aspect of the present invention to provide a device for measuring and/or monitoring air quality in the atmosphere which has no or a very low power draw and a quick response time.

It is a yet further object of at least one aspect of the present invention to provide a device for measuring and/or monitoring air quality in the atmosphere and displaying the measured level of pollution to a user in an easily readable format.

It is a yet further object of at one aspect of the present invention to provide a device for measuring and/or monitoring air quality in the atmosphere and displaying the measured level of pollution to a user in an easily readable format which is capable of being attached onto a child's buggy.

### SUMMARY OF THE INVENTION

According to a first aspect of the present invention there is provided a device capable of measuring and/or monitoring air quality levels in the atmosphere, said device comprising:

a gas sensor capable of measuring air quality levels;

a processing means for processing information collected from the gas sensor;

display means for displaying the level of air quality measured by the gas sensor and processed by the processing means; and

wherein the measured air quality levels are capable of being displayed as a cigarette equivalent or in a readable and understandable format.

The present invention therefore relates to a device that operates as a translator of a surrounding environments air quality to a user through a translation of, for example, the pollutants concentration in ppm (e.g. NO_{X} ppm) to for example, a “cigarette per day” equivalent. For example, if the measured concentration of NO_{X} is multiplied by 0.3456 this may give a measure of the pollutants in the atmosphere in relation to smoking a “cigarette per day” equivalent. The localised atmosphere is measured meaning that this may vary as a user using the device walks about.

Typically, the air quality (e.g. pollution levels) may be measured by measuring the level of nitrogen oxide based gases (i.e. NO_{X}) in the atmosphere. In alternative embodiments, levels of ozone (O₃) and substances known as particulate matter (PM) may be measured. In specific embodiments, particulate matter (PM) known as PM 10 and PM 2.5 may be measured.

The gas sensor may be an electrochemical gas which may detect polluting gases by producing a chemical reaction between the pollutant gas being measured and oxygen contained in the sensor. This reaction may produce a small current, which may be proportional to the concentration of the polluting gas present. A typical sensor is described in U.S. Pat. No. 5,906,718, which is incorporated herein by reference.

In particular embodiments, the electrochemical sensor may comprise two electrodes: a sensing electrode; and a counter electrode. A separator may be located between the sensing electrode and the counter electrode.

Chemical reactions may occur on the sensing electrode and the counter electrode which when combined together produce a current which in turn may allow the sensing process to occur. Current flowing from the sensing electrode and the counter electrode may be collected by current collectors.

Typically, the electrochemical sensor may also comprise a capillary diffusion barrier. The capillary diffusion barrier may take the form of a small opening such as a hole or may be in the form of a capillary in a sensor housing.

The electrochemical gas sensor may be contained within a housing. Within the housing there may be an electrolyte such as an acid, for example, H₂SO₄.

The electrochemical gas sensor may also comprise sensor pins and there may, for example, be two sensor pins. The sensor pins may be used to detect the level of polluting gas such as, for example, NO_{X}.

Typically, the electrochemical sensor may operate in a detection range for pollutants of about 0-1000 ppm, about 0-500 ppm or preferably about 0-200 ppm. A range of about 0-200 ppm may be preferred as a value of about 100 ppm is thought to be about the maximum reading that may be obtained. It is also preferred that the output of the electrochemical sensor may have a linear or substantially linear relationship between ppm of the polluting gas being measured and the obtained current as this reduces complexity in, for example, PIC programming and the error in the outputted value.

The measured pollution value of pollutant (e.g. NO_{X}) may therefore be displayed in the display means such as an easy to read LCD display screen with, for example, a decimal based array of LED's. Alternatively, a specific number in number of cigarettes smoked per day may be displayed.

The processing means may convert the measured level of pollution levels to a “cigarette per day” equivalent. Any suitable form of processing means may be used to obtain the required conversion.

The sensor (e.g. electrochemical sensor) may be controlled using any suitable form of electronic means such as a microprocessor.

The device may be portable and lightweight and may therefore be carried around by a user.

An audible alarm and/or vibrating function and/or flashing light mechanism may also be integrated into the device. The audible alarm and/or vibrating function and/or flashing light mechanism may be activated when a pre-set level of pollutant has been reached. The audible alarm may either emit an alarm signal such as a beeping noise or may provide a warning voice message such as “DANGER”.

The device may be connected and/or attached to a user or apparatus such as a childs buggy mitigating the risk of a child developing asthma.

According to a second aspect of the present invention there is provided a method of measuring and/or monitoring air quality levels in the atmosphere, said method comprising:

providing a gas sensor capable of measuring air quality levels;

providing a processing means for processing information collected from the gas sensor;

providing display means for displaying the level of air quality measured by the gas sensor and processed by the processing means; and

wherein the measured air quality levels are capable of being displayed as a cigarette equivalent or in a readable and understandable format.

### BRIEF DESCRIPTION OF THE DRAWINGS

Embodiments of the present invention will now be described, by way of example only, with reference to the accompanying drawings in which:

FIG. 1 is a representation of sources of polluting gases in the atmosphere;

FIG. 2 is a further representation of sources of polluting gases in the atmosphere;

FIG. 3 is a sectional view of part of a gas sensing device according to an embodiment of the present invention;

FIG. 4 is a representation of a circuit design for operating a gas sensing device according to an embodiment of the present invention;

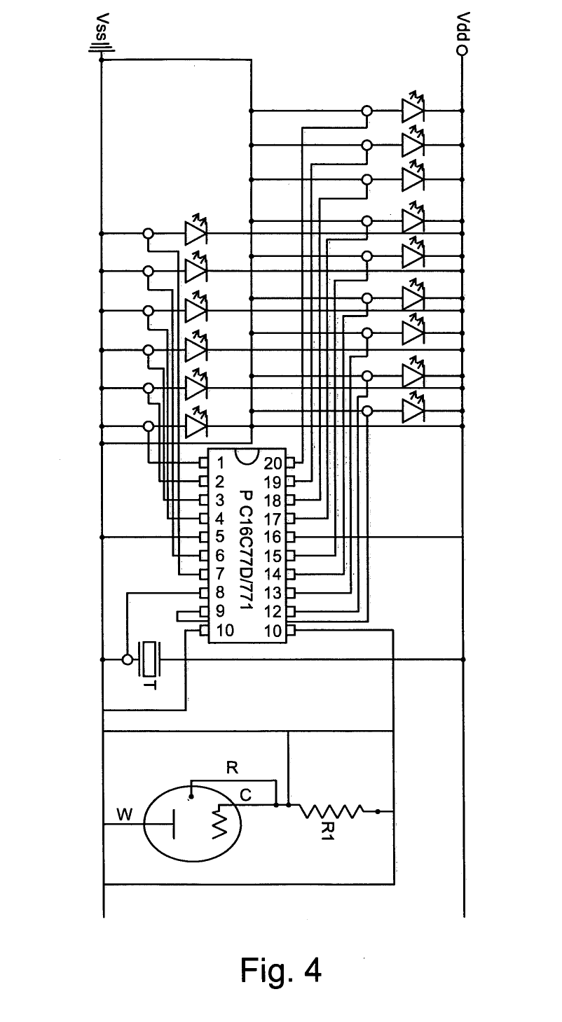

FIG. 5 is a representation of part of the electronics for operating a gas sensing device according to an embodiment of the present invention;

FIG. 6 is a representation of a gas sensing device according to an embodiment of the present invention attached to a human; and

FIG. 7 is a representation of a gas sensing device according to an embodiment of the present invention attached to a child's pushchair.

### BRIEF DESCRIPTION

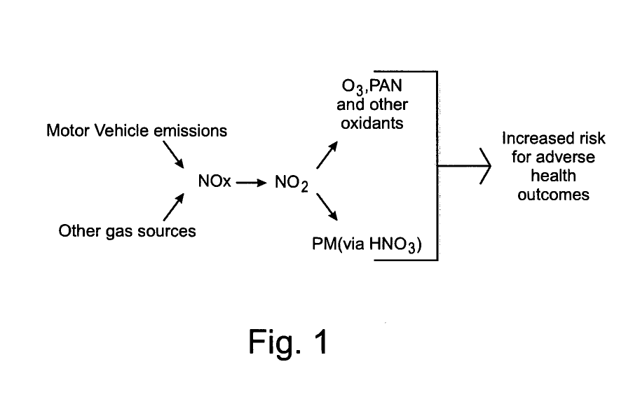

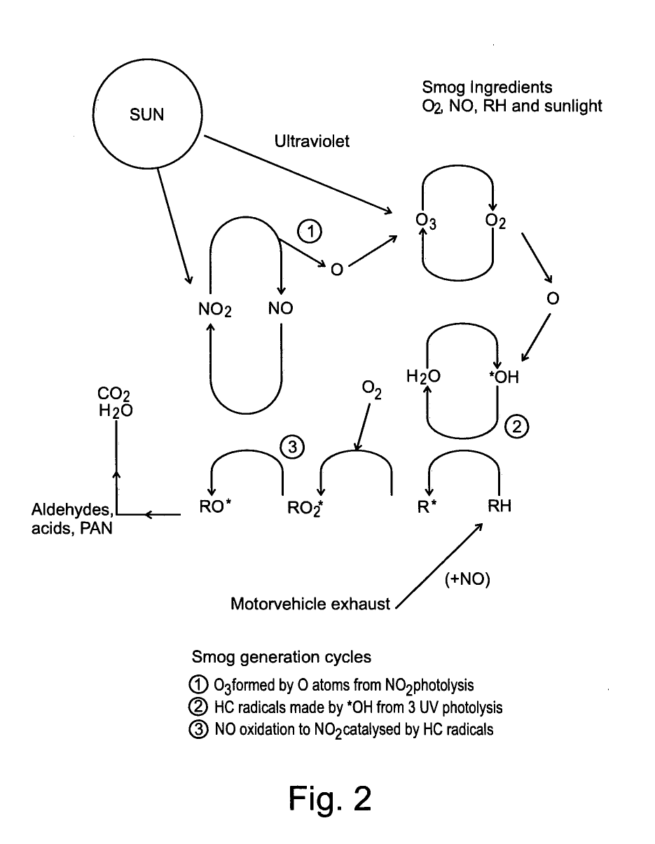

FIGS. 1 and 2 are representations of sources of polluting gases. NO_{X} are oxides of nitrogen which include NO, NO₂ and nitric acid (HNO₃). The polluting gasses are produced in a variety of ways such as during combustion, in power stations or in internal combustion engines as well as in cigarette and cigar smoke. In areas of high motor vehicle traffic, such as in large cities, the amount of nitrogen oxides emitted into the atmosphere can be quite significant.

The present invention is particularly suited to measuring the level of NO_{X} as a pollutant in the atmosphere. The device of the present invention therefore measures the level of NO, NO₂ and HNO₃. One advantage that NO_{X} possesses as the target gas to be measured is that the concentration can be equated to a cigarette equivalent i.e. the amount of NO_{X} produced by smoking a single cigarette. This is shown below:
a standard light cigarette contains 25 mg of NO_{X};
we assume that an average adult at rest breathes 6 litres of air per minute;
for a value of NO_{X} concentration of X mg/m³ or as 1 m³=1000 litres NO_{X} concentration=X/1000 μg per litre;
for amount inhaled each minute ═X/1000×6 litres=6×/1000 mg;
to inhale the 25 mg for one cigarette=25 (6×/1000) minutes=25,000/6X
for daily equivalent=24 hours/(25,000/6X) minutes=0.3456×‘a day’

Using the above calculation, the amount of NO_{X} contamination in the atmosphere can be equated to that of smoking cigarettes. For example, if the measured concentration of NO_{X} is multiplied by 0.3456 this gives a measure of the pollutants in the atmosphere in relation to smoking cigarettes.

In the present invention although it is possible to measure a range of polluting gasses, the device herein described mainly relates to the measurement of NO_{X}. As will be described below, the device uses an electrochemical gas sensor to detect the surrounding NO_{X} concentration and then translates this value (outputted as a voltage) via means of a microprocessor PIC to an equivalent “cigarette per day” value, which may then be outputted and read by a user on a decimal based array of LED's.

The present invention may therefore relate to using electrochemical sensors. Electrochemical sensors detect gases by producing a chemical reaction between the gas being measured and oxygen contained in the sensor. This reaction produces a small current, which is proportional or substantially proportional to the concentration of the polluting gas present. The sensor is, in effect, a type of fuel cell.

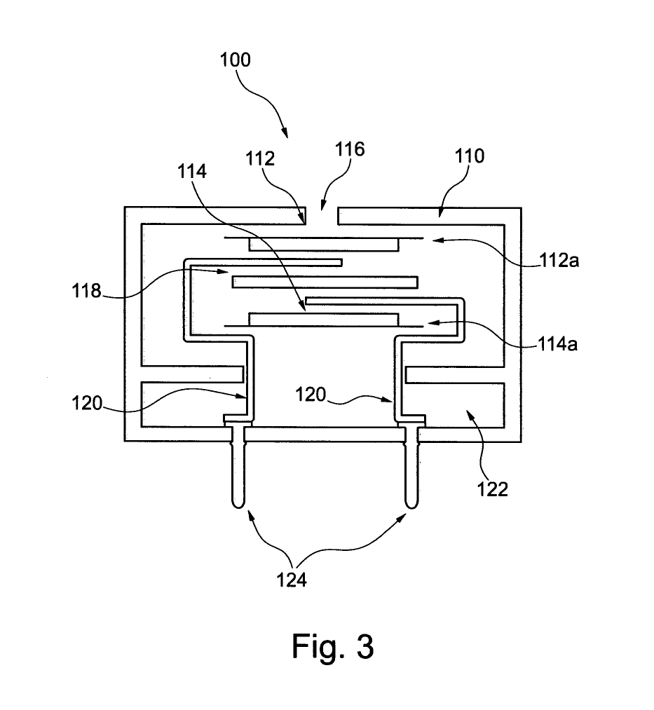

FIG. 3 is a sectional view of part of a gas sensing device according to the present invention showing an electrochemical sensor, generally designated 100. The electrochemical sensor 100 has a housing 110 within which all components are held. The electrochemical sensor 100 comprises two electrodes: a sensing electrode 112; and a counter electrode 114. The sensing electrode 112 and the counter electrode 114 are separated by a separator 118.

Chemical reactions occur on the sensing electrode 112 and the counter electrode 114. These chemical reactions when combined together produce a current which in turn allows the sensing process to occur. Current flowing from the sensing electrode 112 and the counter electrode 114 is collected by current collectors 120. The sensing electrode 112 and the counter electrode 114 comprise small discs of porous PTFE designated 112a and 114a, respectively, onto which is deposited a thin layer of a catalytic metal.

The electrochemical sensor 100 also has a capillary diffusion barrier 116. Because the sensing electrode 112 and the counter electrode 114 have a finite catalytic activity (which can change with time and temperature) it has been found to be necessary to limit the rate of diffusion of target gas (i.e. the pollutant gas) into the sensor 100 using a capillary diffusion barrier 116 to ensure the pollutant gas is efficiently reacted. The capillary diffusion barrier 116 takes the form of a small opening or alternatively is in the form of a capillary in the sensor housing 110.

Within the housing 110 there is an electrolyte such as H₂SO₄.

On one side of the housing 110 there are two sensor pins 124 which are used to detect the polluting gas of, for example, NO_{X}.

For an NO_{X} sensor the electrochemical reaction at each of the sensing electrode 112 and the counter electrode 114 is as follows:

sensing electrode (anode) electrocatalyst

NO₂+2H⁺+2e⁻→NO+H₂OAu

NO+2H₂O→HNO₃+3H⁺+3e⁻Au

counter electrode (cathode) electrocatalyst

H₂O→1/2O₂+2H⁺+2e⁻Au

O₂+4H⁺+4e⁻→2H₂OAu

The preferred type of sensors to be used in the present invention are electrochemical sensors which are chosen as they are ideal for a portable device as they draw no power and a current is produced when the target pollutant gas reacts within the sensor. Electrochemical sensors are also small, light and operate within the required sensitivity, temperature and pressure ranges required for outdoor use. They are also lightweight, robust and provide accurate readings.

Suitable electrochemical sensor samples may be procured and obtained from, for example, Chinese manufacturer Hanwei Electronics Co. LTD. In particular, the ME3 NO_{X} sensor may be chosen due to several key characteristics:
the sensor operates in the detection range of 0-200 ppm, where the application required range was 0-100 ppm as 100 ppm is the equivalent to 70 cigarettes ‘a day’ (the decided maximum reading)
the output of the sensor has a linear relationship between ppm and current and this reduces complexity in the microprocessor such as PIC programming and the error in the outputted value
the response time was suitable for ‘ambient sensor application’

For the output of the sensor to be equated to the ‘cigarette a day’ value the previously derived equation has to be modified for a μA/ppm output:

Volume Mixing Ratio (ppm)=[mass conc. (μg/m³)×RT]/[Pressure×Molar Mass]

For temp of 25° C. and atmospheric pressure of 1 ATM:
mass conc. (g/m³)=X
R=8.314 (gas constant)
T=298 K
Pressure=101.325 kPa
Molecular mass of NO_{X}=46.0055
ppm ═X·24.45/46.0055
X=46.0055 ppm/24.45

As shown above:

$$\begin{matrix}cigarettes per day = 0.3456 X \\ = 0.3456 \times 46.0055 \times ppm / 24.45 \\ = 0.65 ppm\end{matrix}$$

Therefore, in terms of a sensor output:

0.65×I/0.6μ=cigarettes per day
where I is the outputted current in amps

The measured pollution value of NO_{X} may therefore be displayed in, for example, an easy to read LCD display screen in number of cigarettes smoked per day.

The electrochemical sensor 100 of the present invention may be controlled by any suitable form of microprocessor. For example, the microprocessor used may have a minimum of 20 pins and an internal ADC, 18 I/O pins (for a 15 output LED, one output for a transducer, one ADC input for the sensor) and two pins for a power supply. In the event that only an 8 bit microprocessor was required for the internal translation, the PIC procured may be the PIC16C770/771 to satisfy all requirements. It was noted that the PIC16C770/771 was available in many configurations, the three applicable for the device of the present invention were the 20-Lead Plastic Dual In-line (P)—300 mil (PDIP), 20-Lead Plastic Dual Inline (P)—300 mil (SSOP) and the 20-Lead Plastic Small Outline (SO)—Wide, 300 ml (SOIC). The SSOP and the SOIC are of considerably smaller form and therefore advantageous for the present invention.

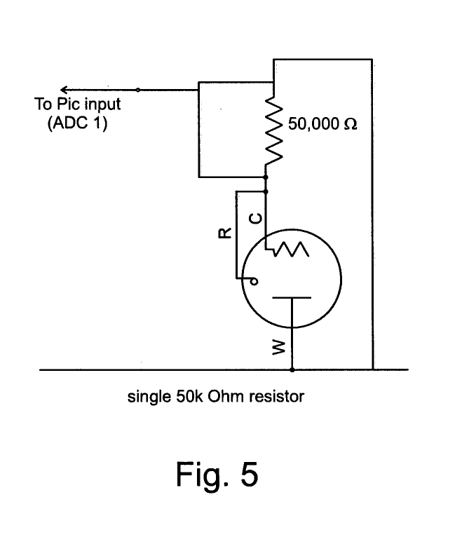

With the procurement of the ME3 NO_{X} electrochemical sensor and the design and specification of the feedback LED array, the electronic circuit and flow of the product was designed. As the output from the electrochemical sensor in terms of ppm was in the form of a current, the sensor was hooked up in series with a load resistor for a voltage to be produced that could be read by the analogue to digital converter (ADC) of the PIC. This is shown in the circuit diagram shown in FIG. 5.

The value of R1 in the circuit shown in FIG. 5 was calculated under the premise that the maximum detected range would be 100 ppm, an equivalent of 69 ‘cigarettes a day’. For this value to be processed by the internal ADC in the PIC, the corresponding voltage into pin ADC1 would have to equal V_{dd} (3V) which would correspond to the highest byte reading of 255.

FIG. 5 shows the use of a single 50,000Ω resistor and the output to PIC input (ADC1) which as shown below calibrates the device to 69 cigarettes for 100 ppm of NO_{X}.

output from sensor=0.6 μA±0.15

3V V_{dd} input to PIC→equivalent to 69 cigarettes output

69 cigarettes=100 ppm

→I=100×0.6μ=6×10⁻⁵ A
V=IR
3=6×10⁻⁵×R
R=50,000Ω

The method outlined above would be suitable for an electrochemical sensor of two pin configuration, however for a sensor with a three pin configuration (where the sensor requires a reference electrode) a potentiostatic circuit is required.

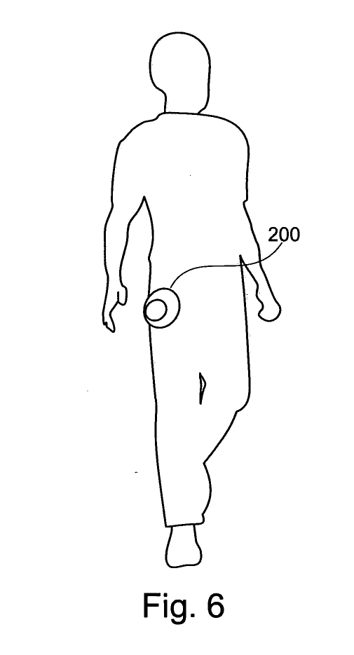

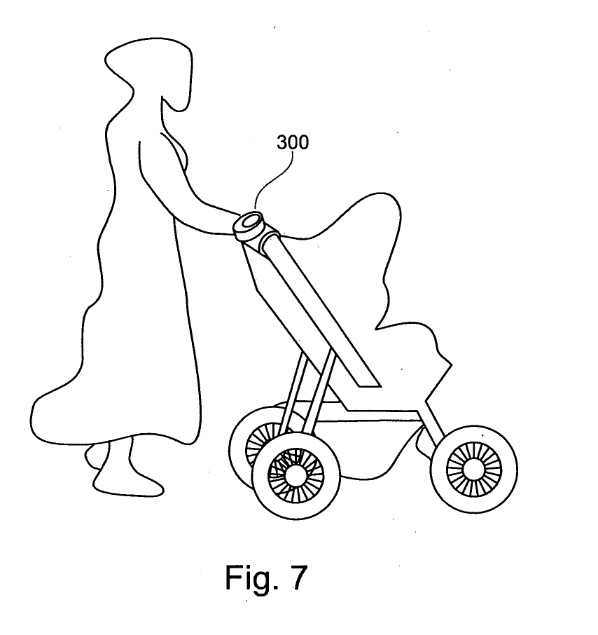

FIG. 6 is a representation of a sensor 200 attached to a human and FIG. 7 is a representation of a sensor 300 attached to a children's pushchair.

Whilst specific embodiments of the present invention have been described above, it will be appreciated that departures from the described embodiments may still fall within the scope of the present invention. For example, any suitable type of sensor may be used in the present invention. Moreover, any suitable electronic circuitry and control components may be used to operate the electrochemical sensor. Any suitable form of calibration may also be used to arrive at a “cigarette per day” equivalent.

1-21. (canceled)

22. A device capable of measuring and/or monitoring air quality levels in the atmosphere, said device comprising:
a gas sensor capable of measuring air quality levels;
a processing means for processing information collected from the gas sensor;
display means for displaying the level of air quality measured by the gas sensor and processed by the processing means; and
wherein the measured air quality levels are capable of being displayed as a cigarette equivalent or in a readable and understandable format.

23. The device capable of measuring and/or monitoring air quality levels in the atmosphere according to claim 22, wherein the device operates as a translator of a surrounding environments air quality to a user through a translation of pollutants concentration in ppm to a “cigarette per day” equivalent or other easily understandable format.

24. The device capable of measuring and/or maintaining air quality levels in the atmosphere according claim 22, wherein the gas sensor is an electrochemical gas sensor

25. The device capable of measuring and/or monitoring air quality levels in the atmosphere according to claim 22, wherein the measured air quality is based on NO₂ ppm concentration.

26. The device capable of measuring and/or monitoring air quality levels in the atmosphere according to claim 22, wherein the measured air quality is based on NO₂ ppm concentration which is multiplied by a multiplier such as 0.3456 to give a measure of pollutants in the atmosphere in relation to smoking a “cigarette per day” equivalent.

27. The device capable of measuring and/or monitoring air quality levels in the atmosphere according to claim 22, wherein the gas sensor detects polluting gases by producing a chemical reaction between the pollutant gas being measured and oxygen contained in the sensor.

28. The device capable of measuring and/or monitoring air quality levels in the atmosphere according to claim 22, wherein the gas sensor is an electrochemical gas sensor comprising two electrodes: a sensing electrode; and a counter electrode or a three pin configuration including a reference electrode, and wherein a separator is located between the sensing electrode and the counter electrode.

29. The device capable of measuring and/or monitoring air quality levels in the atmosphere according to claim 22, wherein the electrochemical sensor comprises a capillary diffusion barrier and the capillary diffusion barrier is in the form of a small opening.

30. The device capable of measuring and/or monitoring air quality levels in the atmosphere according to claim 22, wherein the electrochemical gas sensor is contained within a housing and within the housing there is an electrolyte.

31. The device capable of measuring and/or monitoring air quality levels in the atmosphere according to claim 22, wherein the electrochemical gas sensor comprises sensor pins.

32. The device capable of measuring and/or monitoring air quality levels in the atmosphere according to claim 22, wherein the device is capable of operating in a detection range for pollutants of about 0-1000 ppm, about 0-500 ppm or about 0-200 ppm.

33. The device capable of measuring and/or monitoring air quality levels in the atmosphere according to claim 22, wherein the measured air quality value is displayed in the display means, and the display means is an LCD display screen, or a light guided light emitting diode feedback array.

34. The device capable of measuring and/or monitoring air quality levels in the atmosphere according to claim 22, wherein the device comprises an audible alarm and/or vibrating function and/or flashing light mechanism, or the air quality level is displayed using a traffic light system (e.g. green, amber, red).

35. The device capable of measuring and/or monitoring air quality levels in the atmosphere according to claim 22, wherein the device is capable of being attached to a child's push chair (e.g. a buggy).

36. The method of measuring and/or monitoring air quality levels in the atmosphere, said method comprising:
providing a gas sensor capable of measuring air quality levels;
providing a processing means for processing information collected from the gas sensor;
providing display means for displaying the level of air quality measured by the gas sensor and processed by the processing means; and
wherein the measured air quality levels are capable of being displayed as a cigarette equivalent or in a readable and understandable format.
